(19) United States
(12) Patent Application Publication
(10) Pub. No.: US 2025/0115164 A1
(43) Pub. Date: Apr. 10, 2025

(54) BATTERY SYSTEM

(71) Applicants: TOYOTA JIDOSHA KABUSHIKI KAISHA, Toyota-shi (JP); DENSO CORPORATION, Kariya-city (JP)

(72) Inventors: Shinya ASAURA, Numazu-shi (JP); Hirotsugu OHATA, Susono-shi (JP); Ryuji OMATA, Kariya-city (JP); Takahiro IWAMURA, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 18/765,529

(22) Filed: Jul. 8, 2024

(30) Foreign Application Priority Data
Oct. 4, 2023 (JP) 2023-172859

(51) Int. Cl. B60L 58/27

(52) U.S. Cl. CPC B60L 58/27; B60L 2210/44

(57) ABSTRACT

Direct-current power of a battery is converted to alternating-current power by an inverter to drive a motor generator. A control ECU executes temperature raising control when the battery is at a low temperature. During the temperature raising control, the control ECU superimposes a current ripple for raising the temperature of the battery on a d-axis current command value. A frequency of the current ripple (ripple frequency) varies randomly around a resonance frequency of a battery circuit including the battery. Additionally, a carrier frequency of the inverter varies randomly. As a result, a sound pressure level can be suppressed in regions of the resonance frequency and the carrier frequency during the temperature raising control.

### CROSS-REFERENCE TO RELATED APPLICATION

This application claims priority to Japanese Patent Application No. 2023-172859 filed on Oct. 4, 2023, incorporated herein by reference in its entirety.

### BACKGROUND

### 1. Technical Field

The present disclosure relates to a battery system.

### 2. Description of Related Art

Chinese Patent Application Publication No. 113206324 discloses heating a battery by a high frequency alternating current heating method. Chinese Patent Application Publication No. 113206324 states that a high frequency alternating current pulse current having a frequency that is half the switching frequency of an insulated gate bipolar transistor (IGBT) generates Joule heat due to the internal resistance of the battery, thus heating the battery. Chinese Patent Application Publication No. 113206324 describes varying the switching frequency randomly to reduce the sound pressure level of harsh noise generated by the high frequency alternating current.

### SUMMARY

An inverter is driven at a predetermined switching frequency (carrier frequency). In Chinese Patent Application Publication No. 113206324, a ripple current generated by switching of an inverter (switching ripple current) is used to generate a current ripple to raise the temperature of a battery.

When the frequency of current ripple (hereinafter also referred to as ripple frequency) is controlled to the resonance frequency of the circuit including the battery (battery circuit), the amplitude of the current ripple increases due to resonance, and the temperature of the battery can be raised (heated) efficiently. Therefore, it is conceivable to control the ripple frequency of the current output from the inverter to the resonance frequency of the battery circuit to efficiently raise the temperature of the battery.

When the ripple frequency of the current output from the inverter is controlled to the resonance frequency of the battery circuit, the sound pressure level increases in the region of the carrier frequency and the region of the ripple frequency, leading to concerns about noise generation.

An object of the present disclosure is to efficiently raise the temperature of a battery and to suppress noise while the temperature of the battery is raised.

A battery system according to the present disclosure includes a battery, an electric machine, an inverter, and a control device.

The inverter is connected between the battery and the electric machine, driven at a predetermined carrier frequency, and converts direct-current power stored in the battery into alternating-current power and supplies the alternating-current power to the electric machine. A circuit including the battery has a resonance frequency. The control device is configured so that when the temperature of the battery is raised, the frequency of a current ripple included in a current supplied to the electric machine varies randomly around the resonance frequency, and the carrier frequency varies randomly.

According to this configuration, the direct-current power stored in the battery is converted into alternating-current power by the inverter and supplied to the electric machine. The inverter is driven by the control device at a predetermined carrier frequency. The control device randomly varies the frequency of the current ripple included in the current supplied to the electric machine around the resonance frequency of the circuit including the battery, thereby raising the temperature of the battery. The control device randomly varies the carrier frequency while the temperature of the battery is raised.

Since the frequency of the current ripple output from the inverter is controlled around the resonance frequency of the circuit including the battery, it is possible to efficiently raise the temperature of the battery. Furthermore, since the ripple frequency and the carrier frequency vary randomly, the sound pressure level in the frequency regions is reduced, and the generation of noise can be suppressed.

The electric machine may be a rotating electric machine, and the current ripple may be a ripple of a d-axis current of the rotating electric machine.

According to this configuration, when the temperature of the battery is raised, since the current ripple included in the d-axis current supplied to the rotating electric machine is used, the temperature of the battery can be raised without changing the output torque of the rotating electric machine. The rotating electric machine may be a synchronous motor, for example, an interior permanent magnet (IPM) synchronous motor.

The battery system may be mounted on a vehicle, and the control device may raise the temperature of the battery when a request for external charging of the battery is made and the temperature of the battery is equal to or less than a predetermined value.

According to this configuration, when the temperature of the battery is low during external charging of the electrified vehicle, the temperature of the battery is raised, so external charging can be performed satisfactorily.

The battery system may further include a first heat exchanger that exchanges heat with the rotating electric machine, and a second heat exchanger that exchanges heat with the battery. When the temperature of the battery is raised, the control device may cause heat that is received at the first heat exchanger to be dissipated from the second heat exchanger to raise the temperature of the battery.

While the temperature of the battery is raised, the d-axis current including the current ripple is supplied to the rotating electric machine. Therefore, the rotating electric machine also generates heat. According to this configuration, heat of the rotating electric machine is received at the first heat exchanger, and the received heat is dissipated from the second heat exchanger to the battery. The heat of the rotating electric machine can be used to raise the temperature of the battery, and the temperature of the battery can be raised efficiently.

According to the present disclosure, it is possible to efficiently raise the temperature of a battery, and furthermore, it is possible to suppress noise while the temperature of the battery is raised.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram of a battery system according to a present embodiment;

FIG. 2A is a diagram for explaining a sound pressure level while a temperature of a battery is raised;

FIG. 2B is a diagram for explaining the sound pressure level while the temperature of the battery is raised;

FIG. 3 is a flowchart of battery temperature raising control executed by a control electronic control unit (ECU); and

FIG. 4 is a diagram showing a part of a block diagram of motor generator (MG) control in the present embodiment.

### DETAILED DESCRIPTION OF EMBODIMENTS

Hereinafter, an embodiment of the present disclosure will be described in detail with reference to the drawings. It should be noted that the same or corresponding parts in the drawings are designated by the same reference characters and repetitive description will be omitted.

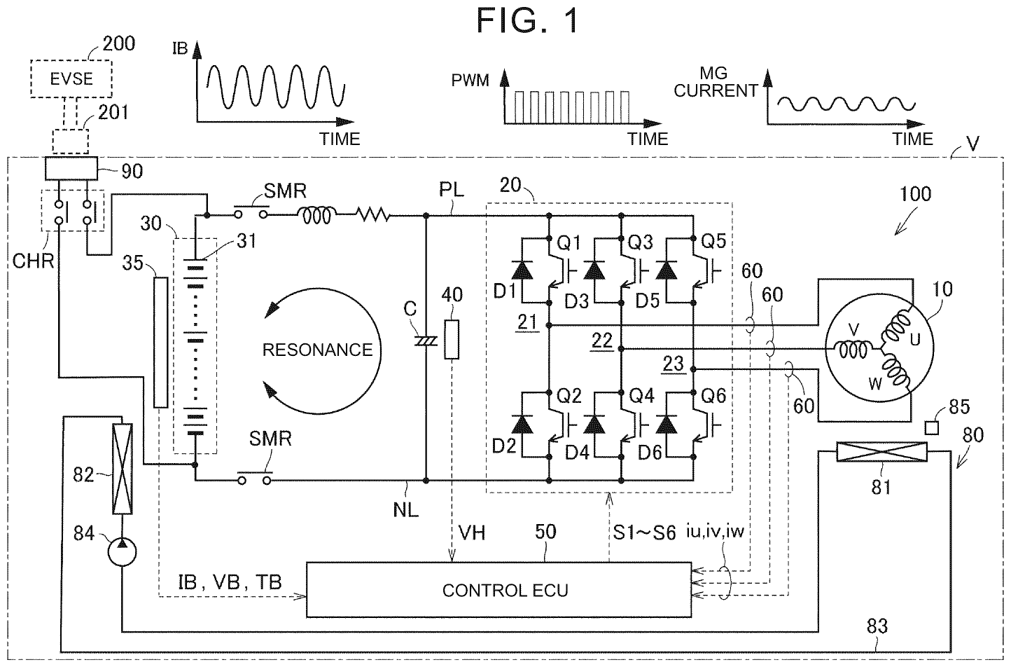

FIG. 1 is an overall configuration diagram of a battery system 100 according to the present embodiment. The battery system 100 according to the present embodiment is mounted on a vehicle V, for example. The vehicle V may be a battery electric vehicle or a plug-in hybrid electric vehicle. Referring to FIG. 1, the battery system 100 includes an MG 10, an inverter 20 as a power control unit (PCU), a battery 30, system main relays SMR, and a control ECU 50 as a control device.

The MG 10 is a drive electric motor that generates torque for driving drive wheels (not shown) of the vehicle V. The MG 10 is a rotating electric machine, for example, an IPM synchronous motor in which permanent magnets embedded in the rotor. Furthermore, the MG 10 may further have a generator function, or may be configured to have both an electric motor function and a generator function. The MG 10 corresponds to an example of the “electric machine” in the present disclosure.

The battery 30 is configured by a secondary battery such as a lithium-ion battery, and corresponds to a “battery” in the present disclosure. The secondary battery may be a battery including a liquid electrolyte between a positive electrode and a negative electrode, or may be a battery including a solid electrolyte between a positive electrode and a negative electrode (all-solid-state battery). The battery 30 is configured as a battery pack in which a plurality of single cells (battery cells) 31 such as lithium-ion batteries are electrically connected in series.

The battery 30 is provided with a monitoring unit 35. The monitoring unit 35 includes a sensor that detects a voltage VB of the single cells 31, an input-output current IB of the battery 30, and a temperature TB of the battery 30, and outputs signals indicating the detection results to the control ECU 50. In the present embodiment, the voltage VB of the single cells 31 is detected by the monitoring unit 35, but the present disclosure is not limited to this. For example, when the single cells 31 constituting the battery 30 (battery pack) are divided into a plurality of battery blocks, the voltage of each of the battery blocks may be detected. Alternatively, the entire voltage of the battery 30 (battery pack) may be detected.

One of the system main relays SMR is connected between the positive terminal of the battery 30 and a power line PL, and the other of the system main relays SMR is connected between the negative terminal of the battery 30 and a power line NL. The 15 system main relays SMR are each switched between an open state and a closed state by a control signal from the control ECU 50.

A capacitor C connected between the power line PL and the power line NL is provided between the inverter 20 and the battery 30. The capacitor C smooths battery voltage and supplies the battery voltage to the inverter 20. A voltage sensor 40 detects a voltage across the capacitor C, that is, a voltage VH between the power line PL and the power line NL connecting the battery 30 and the inverter 20 (hereinafter also referred to as “system voltage”), and outputs a signal indicating the detection result to the control ECU 50.

The inverter 20 converts the direct-current power supplied from the battery 30 into alternating-current power and supplies the alternating-current power to the MG 10. The inverter 20 also converts the alternating-current power generated by the MG 10 into direct-current power and supplies the direct-current power to the battery 30. That is, the battery 30 can transmit and receive power to and from the MG 10 via the inverter 20.

The inverter 20 includes a U-phase arm 21, a V-phase arm 22, and a W-phase arm 23. The phase arms are connected in parallel with each other between the power line PL and the power line NL. The U-phase arm 21 has switching elements Q1, Q2 connected in series with each other. The V-phase arm 22 has switching elements Q3, Q4 connected in series with each other. The W-phase arm 23 has switching elements Q5, Q6 connected in series with each other. Between the collector and emitter of each of the switching elements Q1 to Q6, diodes D1 to D6 are connected in reversely parallel to the switching elements Q1 to Q6, respectively. Switching operations of the switching elements Q1 to Q6 are performed by control signals (gate signals) S1 to S6 from the control ECU 50.

The midpoint of each of the phase arms is connected to each phase end of each phase coil of the MG 10. The other ends of the three coils of U phase, V phase, and W phase of the MG 10 are commonly connected to a neutral point. Current sensors 60 detect three-phase currents iu, iv, iw flowing in the MG 10, and output signals indicating the detection results to the control ECU 50.

The vehicle V includes an inlet 90, and the battery 30 is charged using power from an external power source. The inlet 90 is connected to a positive terminal and a negative terminal of the battery 30 via charging relays CHR. When a plug 201 of a charging equipment (electric vehicle supply equipment (EVSE)) 200 is connected to the inlet 90 and the charging relays CHR are closed, charging by an external power source (external charging) becomes possible.

When the temperature TB of the battery 30 is low, charging and discharging performance deteriorates due to an increase in internal resistance and the like. Therefore, when the temperature TB of the battery 30 is low, it is desirable to raise the temperature of the battery 30. It is conceivable to cause a ripple current to flow through the battery 30 to generate a current ripple, and to raise the temperature of the battery 30 using the generated Joule heat. The inverter 20 is pulse width modulation (PWM) controlled by the control ECU 50 at a predetermined carrier frequency. When the MG 10 is rotationally driven, the MG 10 is sine-wave driven by the inverter 20, and the waveform of the current (MG current) supplied from the inverter 20 to the MG 10 becomes a sine wave. By superimposing a current ripple for increasing the temperature of the battery 30 on the MG current, a ripple current for increasing the temperature can be caused to flow through the battery 30.

A battery circuit (LC series circuit or RLC series circuit) including the battery 30 and the capacitor C has a resonance frequency Rf. When the frequency (ripple frequency) of the current ripple for raising the temperature of the battery 30 matches the resonance frequency Rf, the amplitude of the current ripple increases due to resonance and the amount of Joule heat generated raises, which enables the temperature of the battery 30 to be raised efficiently.

Since the PWM control of the inverter 20 switches the switching elements Q1 to Q6 at a carrier frequency Cf, the switching operation is used as an oscillation source to generate a switching ripple current at the carrier frequency Cf. Therefore, when the ripple frequency is controlled to the resonance frequency Rf, the sound pressure level increases in the region of the resonance frequency Rf and the region of the carrier frequency Cf.

The upper part of FIG. 1 shows the current IB of the battery 30, the duty of the PWM control, and the MG current, and when the ripple frequency matches the resonance frequency Rf, the amplitude of the current IB increases. Note that a small amplitude corresponding to the carrier frequency Cf is superimposed on the current IB and the MG current, but the amplitude is not shown.

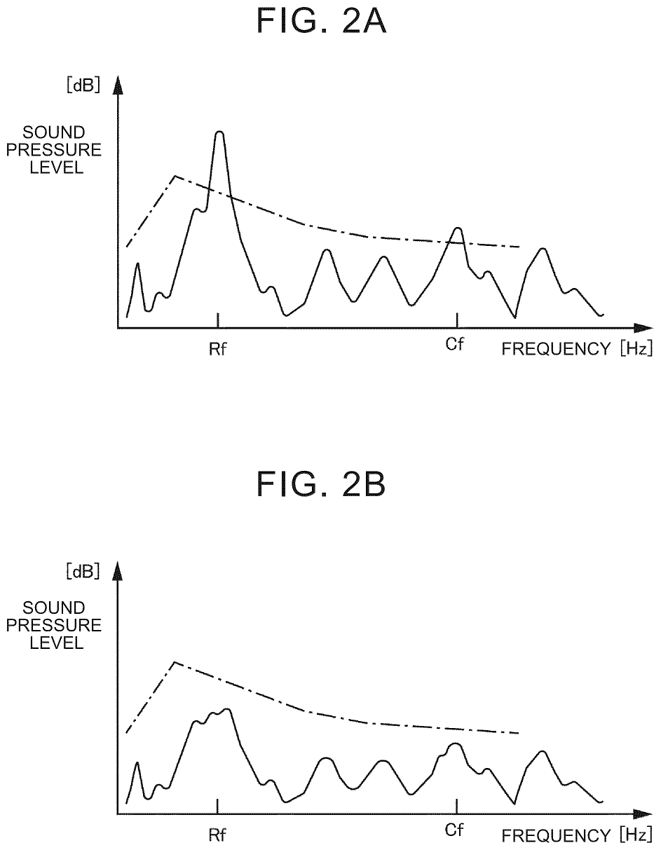

FIGS. 2A and 2B are diagrams for explaining the sound pressure level while the temperature of the battery 30 is raised. When the resonance frequency Rf is superimposed on the MG current to raise the temperature of the battery 30, the sound pressure level raises in the region of the resonance frequency Rf and the region of the carrier frequency Cf, as shown in FIG. 2A. In FIGS. 2A and 2B, the dashed line indicates the sound pressure level that is acceptable for noise and hearing feeling. In the present embodiment, when the temperature of the battery 30 is raised, the ripple frequency and carrier frequency are randomly varied to reduce the sound pressure level in the region of the resonance frequency Rf and the region of the carrier frequency Cf.

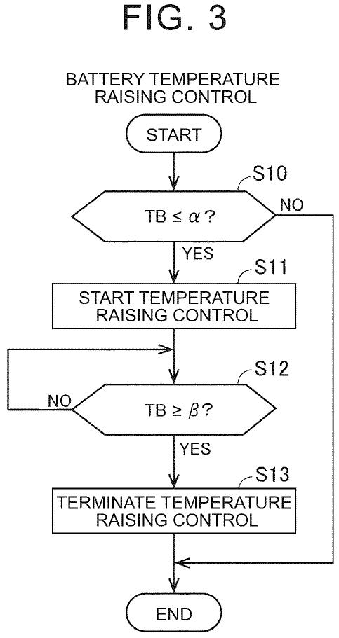

FIG. 3 is a flowchart of battery temperature raising control executed by the control ECU 50. The flowchart is executed when a request for external charging (charging request) of the battery 30 is made. For example, it may be assumed that a charging request is made when the plug 201 is connected to the inlet 90 and a charging instruction is issued. Furthermore, in a case where timer charging is set, it may be determined that a charging request is made when the time is before a set time from a charging start time. When a charging request is made, the control ECU 50 determines in step (hereinafter, step is abbreviated as “S”) 10 whether the temperature TB of the battery 30 is equal to or less than a predetermined value α. The predetermined value α may be, for example, 0 [° C.]. When the temperature TB is equal to or less than the predetermined value α, an affirmative determination is made, and the process proceeds to S11. When the temperature TB is higher than the predetermined value α, the current routine is terminated.

In S11, temperature raising control is executed. The temperature raising control is an MG control that controls the MG. The temperature raising control controls the inverter 20 in such a manner that the frequency of the current ripple (ripple frequency) included in the MG current varies randomly around the resonance frequency Rf of the battery circuit, and the carrier frequency Cf varies randomly.

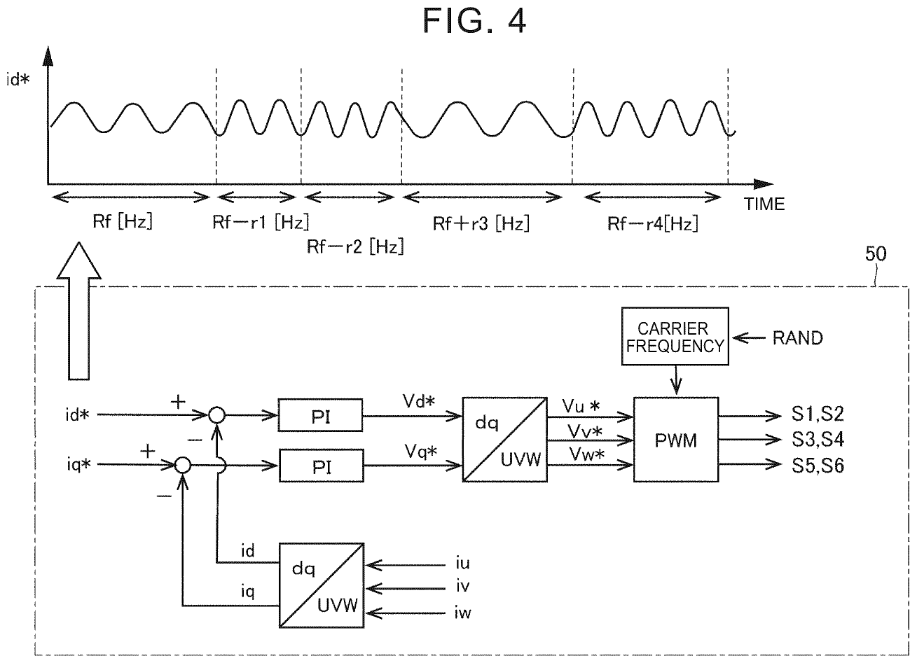

FIG. 4 is a diagram showing a part of a block diagram of the MG control in the present embodiment. Software (programs) and hardware of the control ECU 50 cooperate to configure the functions of the block diagram. The control ECU 50 performs UVW-dq conversion on the three-phase currents iu, iv, iw detected by the current sensors 60 to obtain a d-axis current id and a q-axis current iq. Furthermore, the control ECU 50 calculates a d-axis current command value id* and a q-axis current command value iq* based on an output torque command value. Then, a d-axis voltage command Vd* is obtained by proportional-integral (PI) control using the d-axis current command value id* and the d-axis current id, and a q-axis voltage command Vq* is obtained by PI control using the q-axis current command value iq* and the q-axis current iq.

The control ECU 50 performs dq-UVW conversion on the d-axis voltage command Vd* and the q-axis voltage command Vq* to obtain three-phase voltage commands Uv*, Vv*, Wv*. The control signals S1 to S6 are generated by the PWM control using the carrier frequency Cf to drive the inverter 20 so that voltages of the three-phase voltage commands Uv*, Vv*, Wv* are supplied to the U phase, V phase, and W phase of the MG 10, respectively.

Since the temperature raising control in S11 is performed when charging is requested, the temperature raising control is performed while the MG 10 is stopped. Therefore, the q-axis current command value iq* of the MG 10 is set to zero. A current ripple for raising the temperature of the battery 30 is superimposed on the d-axis current command value id*, and the waveform of the d-axis current command value id* becomes the waveform of the ripple current flowing through the battery 30. As shown in the upper part of FIG. 4, the ripple frequency of the d-axis current command value id* is controlled to vary randomly around the resonance frequency Rf of the battery circuit. The range of variation of the ripple frequency is arbitrary, and may be, for example, in the range of ±3 to 20% of the resonance frequency Rf. For example, when the resonance frequency Rf is 1300 [Hz], the ripple frequency may be varied randomly within the range of ±150 [Hz]. The method of randomly varying the ripple frequency may be arbitrary; for example, a RAND function or a RANDBETWEEN function may be used.

Furthermore, in the temperature raising control, the carrier frequency Cf of the PWM control is also controlled to vary randomly. The range of variation of the carrier frequency is arbitrary, and may be, for example, in the range of ±1 to 10% of the carrier frequency Cf. For example, when the carrier frequency Cf is 4500 [Hz], the carrier frequency Cf may be varied randomly within the range of ±150 [Hz].

Returning to FIG. 3, in subsequent S12, it is determined whether the temperature TB of the battery 30 is equal to or higher than a predetermined value β. The predetermined value β is a value larger than the predetermined value α, and may be, for example, 15 [° C.]. When the temperature TB is lower than the predetermined value β, the temperature raising control is continued. When the temperature TB is equal to or higher than the predetermined value, the process proceeds to S13, where the drive of the inverter 20 is stopped and the MG current is set to zero, and after the temperature raising control is completed, the current routine is terminated. Note that during temperature raising control, the system main relays SMR are closed.

In the present embodiment, during the temperature raising control of the battery 30, the ripple frequency of the d-axis current command value id* is controlled to vary randomly around the resonance frequency Rf of the battery circuit. As a result, the ripple frequency of the MG current varies randomly around the resonance frequency Rf of the battery circuit, so the current flowing through the battery 30 also varies randomly around the resonance frequency Rf of the battery circuit. Therefore, the amplitude of the ripple current flowing through the battery 30 increases, and the temperature of the battery 30 can be raised (heated) efficiently. Furthermore, by randomly varying the ripple frequency and the carrier frequency, the sound pressure level in the region of the resonance frequency Rf and the region of the carrier frequency Cf decreases. As shown in FIG. 2A, the sound pressure level increases in the region of the resonance frequency Rf and the region of the carrier frequency Cf due to the ripple current and the switching ripple current. By randomly varying the ripple frequency and the carrier frequency, the sound pressure level in the region of the resonance frequency Rf and the region of the carrier frequency Cf decreases, as shown in FIG. 2B.

### Modification

In the embodiment described above, during the temperature raising control of the battery 30, since the MG current (d-axis current) flows to the MG 10, the MG 10 also generates heat. In a modification, the heat generated by the MG 10 during the temperature raising control is also used to raise the temperature of the battery 30.

In the modification, a temperature raising circuit 80 is added, as shown in FIG. 1. The temperature raising circuit 80 includes a first heat exchanger 81 that exchanges heat with the MG 10, a second heat exchanger 82 that exchanges heat with the battery 30, a flow path 83 through which a heat medium flows, and a pump 84 that circulates the heat medium. When a temperature MT of the MG 10 detected by an MG temperature sensor 85 is higher than the temperature TB during the temperature raising control of the battery 30 (after an affirmative determination is made in S10), the control ECU 50 drives the pump 84 to make the heat medium circulate in the flow path 83. As a result, the heat of the MG 10 received at the first heat exchanger 81 can be dissipated from the second heat exchanger 82 to the battery 30, and the battery 30 can be heated (raised in temperature).

In the modification, when the temperature MT is higher than the temperature TB, the pump 84 is driven to circulate the heat medium in the flow path 83. In a case where a heat pump structure in which a compressor and an expansion valve are provided in the flow path 83 is adopted as the temperature raising circuit 80, even when the temperature MT is lower than the temperature TB, it is also possible to pump out the heat of the MG 10 by the heat pump to heat the battery 30.

In the embodiment described above, the temperature raising control of the battery 30 is performed when a charging request is made. However, even when a charging request is not made, the temperature raising control may be executed when the temperature TB of the battery 30 is low. In this case, a current ripple for raising the temperature of the battery 30 is superimposed on the d-axis current command value id* calculated based on the output torque command value, and the d-axis current command value id* that is input to a PI controller is generated. At this time, the frequency of the current ripple (ripple frequency) is controlled to vary randomly around the resonance frequency Rf, and the carrier frequency Cf is also controlled to vary randomly.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A battery system comprising:
a battery;
an electric machine;
an inverter that is connected between the battery and the electric machine, driven at a predetermined carrier frequency, and converts direct-current power stored in the battery into alternating-current power and supplies the alternating-current power to the electric machine; and
a control device, wherein
a circuit including the battery has a resonance frequency, and
when a temperature of the battery is raised, the control device controls the inverter in such a manner that a frequency of a current ripple included in an alternating current supplied to the electric machine varies randomly around the resonance frequency and the carrier frequency varies randomly.

2. The battery system according to claim 1, wherein:
the electric machine is a rotating electric machine; and
the current ripple is a ripple of a d-axis current of the rotating electric machine.

3. The battery system according to claim 2, wherein:
the battery system is mounted on a vehicle; and
the control device raises the temperature of the battery when a request for external charging of the battery is made and the temperature of the battery is equal to or less than a predetermined value.

4. The battery system according to claim 3, further comprising:
a first heat exchanger that exchanges heat with the rotating electric machine; and
a second heat exchanger that exchanges heat with the battery, wherein when the temperature of the battery is raised, the control device causes heat that is received at the first heat exchanger to be dissipated from the second heat exchanger to raise the temperature of the battery.
